(19) United States
(12) Patent Application Publication
(10) Pub. No.: US 2019/0392723 A1
(43) Pub. Date: Dec. 26, 2019

(54) Process for Automating the Authoring and Assembly of Adaptive Learning Modules

(71) Applicant: Alchemy Systems, L.P., Austin, TX (US)

(72) Inventors: Terence Patrick McGuire, Waterloo (CA); Ian Kennedy, Waterloo (CA); Mark Peters, Kitchener (CA); Salvatore Scozzari, Ancaster (CA); Scott Martin, Erin (CA)

(73) Assignee: Alchemy Systems, L.P., Austin, TX (US)

(21) Appl. No.: 16/453,754

(22) Filed: Jun. 26, 2019

Related U.S. Application Data
(60) Provisional application No. 62/689,919, filed on Jun. 26, 2018.

(51) Int. Cl. G09B 5/06; G09B 7/02; G06Q 50/20

(52) U.S. Cl. CPC G09B 5/065; G06Q 50/20; G09B 7/02

(57) ABSTRACT

External media elements are created. Then a metadata document is created referencing external media elements. A module assembler then generates an Adaptive Learning Module (“ALM”) from the metadata document and external media elements referenced in the metadata document, wherein the ALM comprises assets and assembly rules. A media player software (“MPS”) generates from the ALM assets and assembly rules, presentation materials usable in a training system, such as LMS.

### CROSS-REFERENCE TO RELATED APPLICATIONS

This application claims the benefit of U.S. Provisional Application No. 62/689,919, filed Jun. 26, 2018, which application is hereby incorporated herein by reference, in its entirety.

### TECHNICAL FIELD

The invention relates generally to professional education and training.

### BACKGROUND

The key problem to solve is the difficulty of authoring and assembling individualized, globalized (multi-language) training content in a manner that is cost-efficient and labor-efficient. The development and construction of effective, individualized training content requires the use of multiple training techniques, such as remediation, variation of content style, adaptation to the learner's context and training history, and the like. These elements, combined with highly individualized content delivery, create dozens, sometimes hundreds, of unique content/training permutations. Use of multiple parallel techniques in the authoring and assembly of content to achieve individual targeting is therefore labor-intensive and time-intensive, so much so that it becomes difficult to deliver effective content in an economically viable manner.

Using traditional methods, training content is authored and assembled in multiple interconnected steps, by multiple individuals that play different roles in a typical organization, all of which have specialized skills. Each step of this process introduces opportunities for delays, errors, and omissions, each of which cause steps to be repeated until the issues are resolved. Additionally, the effort is multiplied due to the need to explicitly review every variant of the training content produced (multiple languages, individualized based on role, department, etc.).

There are third-party off-the-shelf solutions that attempt to provide a content authoring solution that automates this process. Each one of these solutions only meets a subset of the requirements necessary to author and deliver personalized, adaptive learning modules in a cost-effective and time-effective manner.

Prior solutions may allow custom targeting, but they lack scalability, in both the instructional content and module construction processes. Often these solutions require the manual assembly of an initial version of a content object that is used as a template for subsequent duplication. Construction of the template requires the manual insertion of tag parameters which are replaced with object values during the duplication process. Although this is better than manually constructing all the individual content objects, it maintains the following deficiencies:
It does not avoid the necessity of manual effort at every step to build the initial template.
The template object itself is at its core fundamentally a content object, it is not designed to facilitate efficient duplication.
The template solution works when the desired outputs are very similar in structure and content. When the outputs vary considerably, then the management of the template parameters becomes extremely complex, so much so that it is often simpler and faster to create each one individually.
It does nothing to address the need for specialized skills at every step of the process, which in turn limits scalability of the solution.

### SUMMARY

The present invention, accordingly, provides a process that can create individually targeted Adaptive Learning Modules (“ALM”) in twenty languages in fifteen minutes. It achieves this by creating external media elements and a metadata document referencing the external media elements. A module assembler then generates an Adaptive Learning Module (“ALM”) from the metadata document and external media elements referenced in the metadata document, wherein the ALM comprises assets and assembly rules. A media player software (“MPS”) generates from the ALM assets and assembly rules, presentation materials usable in a training system, such as a Learning Management System (“LMS”).

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 depicts a traditional content development process according to the prior art;

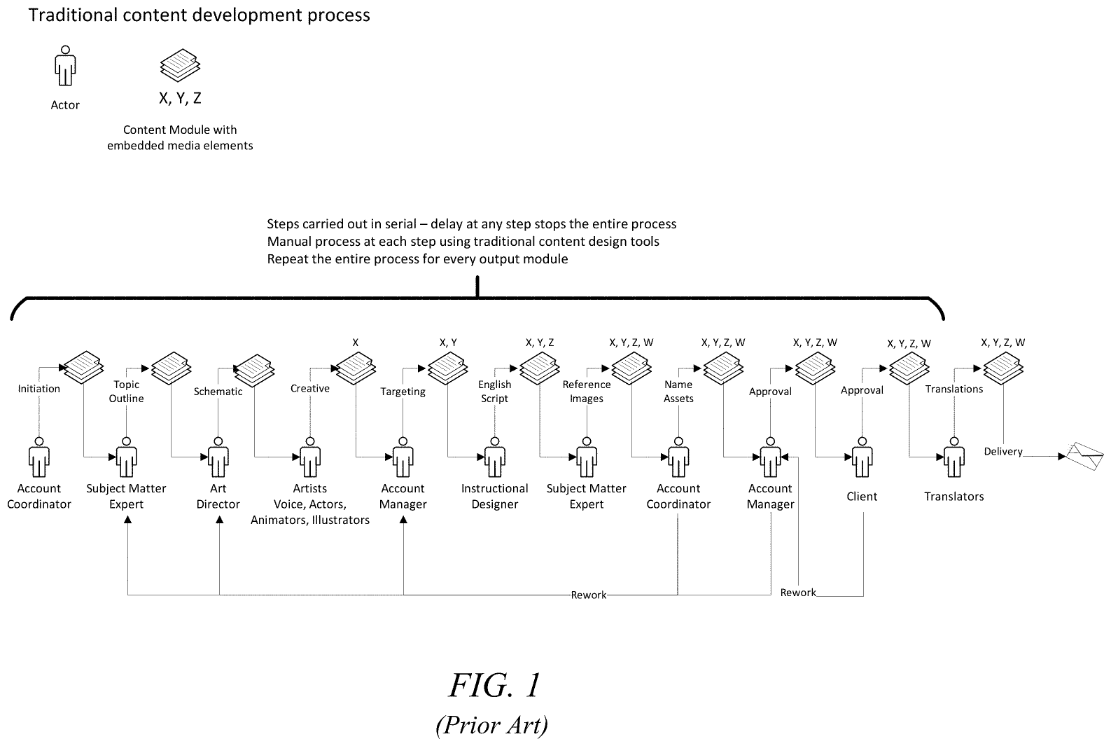

FIG. 2 depicts a solution that leverages template parameters according to the prior art;

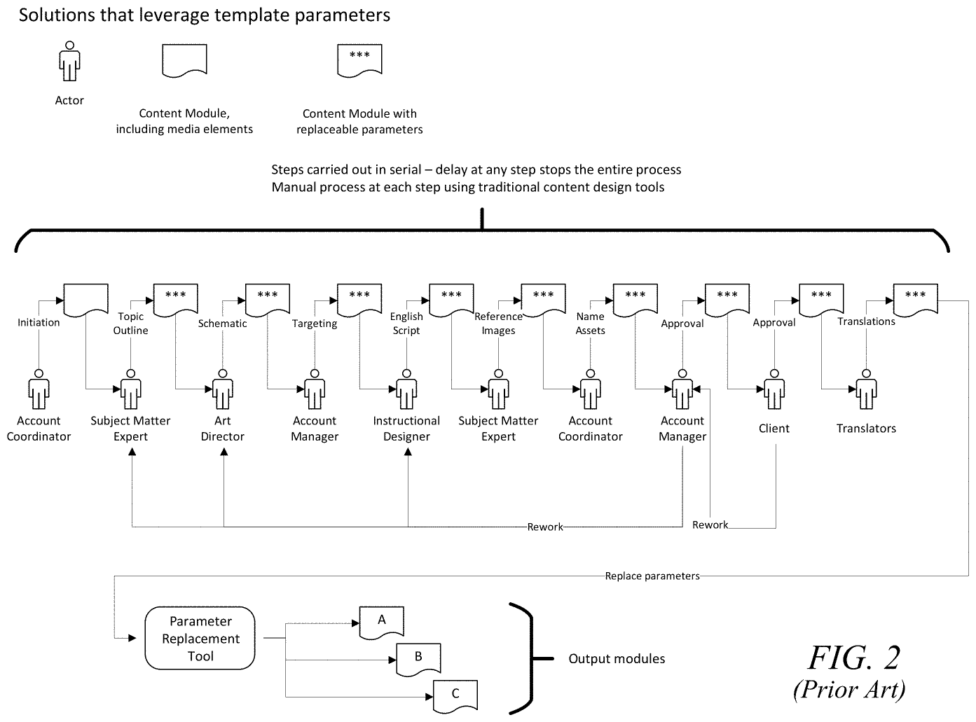

FIG. 3 exemplifies a process embodying principles of the present invention;

FIG. 4 exemplifies an ALM construction process flowchart;

FIG. 5 exemplifies a table of content definition;

FIG. 6 exemplifies a table of quiz definition; and

FIG. 7 exemplifies operation of a module assembler.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation.

It is noted that, unless indicated otherwise, functions described herein may be performed by a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

Using the traditional manual assembly process, a partially completed output content module file, referred to herein as an Adaptive Learning Module (“ALM”), acts as both a repository of the content author's intent and preliminary version of the required final product. These are two fundamentally different types of information, and having them tightly bound in a single ALM causes inefficiencies at every step of the process.

The process of the invention comprises two key elements:
(1) a metadata document that stores an abstract definition of the required ALM; and
(2) a software application referred to herein as a “module assembler” which reads the metadata document and builds an ALM.

To be clear, the content (media files) lives outside of the metadata document. The metadata preferably contains only references to the content by file path or URL. By way of examples, a metadata document may refer to an image using the file path “C:\media\logo.jpg”, and another image using the URL http://media.cdn.com/alchemy/image.jpg. For efficiency and ease of translation, text can be directly included in the metadata document, but these can also be defined as external references to text files.

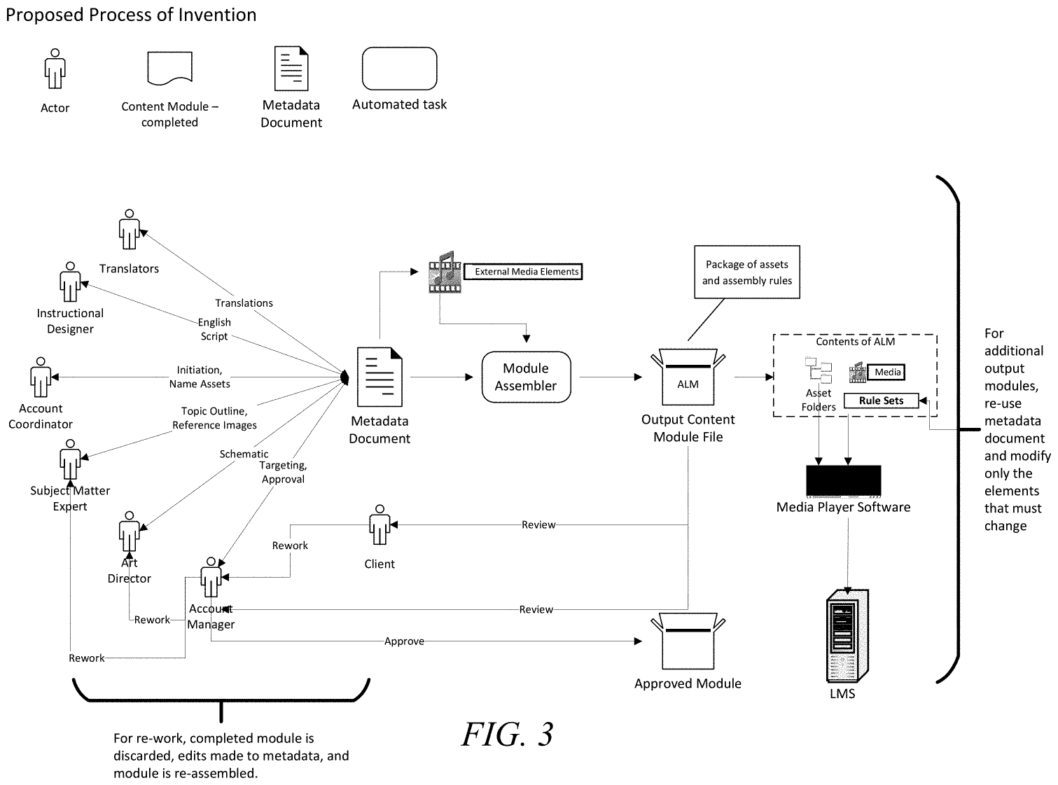

The process and system can be more clearly viewed in FIG. 3, wherein contributors such as subject matter experts, directors, account managers, account coordinators, instructional designers, and translators, input, largely simultaneously, data to create external media elements accessible by reference, and to create a metadata document having text and references to the external media elements. External media elements, as such, may be created as completely new elements for a specific course that is being created. In such a case, the files may be named even before they exist by following a pre-defined naming scheme. Once the elements are created by their respective artists or designers, they are re-named according to what is specified in the metadata document. Additionally, external media elements may comprise elements that already exist and are re-used often, such as a company logo, program branding, and the like.

With external media elements and a metadata document in place, a module assembler then generates a completed ALM from the metadata document text and external media elements referenced in the metadata document. The ALM comprises content, referred to as assets, and low-level instructions (e.g., XML, HTML, image files, video files, audio files, and the like), referred to as assembly rules, which are used by Media Player Software (MPS) to correctly present the assets as intended by the metadata document, referred to herein as “presentation materials” (e.g., PowerPoint slides). The contents of the ALM are preferably stored in a ZIP file, and the MPS extracts those elements from the ZIP file and stores them locally for presentation to the learner. By way of example, a trainee's language preference is saved, and then, whenever an image, video, or audio file needs to be played, the MPS selects the version whose language matches the trainee's language. In a further example, the MPS may be instructed to convert a quiz question into a series of slides, such as PowerPoint slides, generally as follows:
(1) Generate a slide and place question text place on the slide.
(2) Wait for a transition to the next slide.
(3) Generate a slide with buttons, each of which buttons has placed on it one of the possible answers to the question.
(4) Wait for the trainee to select one of the answer buttons.
(5) If the trainee chooses the correct answer, generate a new slide and display positive reinforcement text.
(6) If the trainee chooses an incorrect answer, generate a slide and display remediation text.

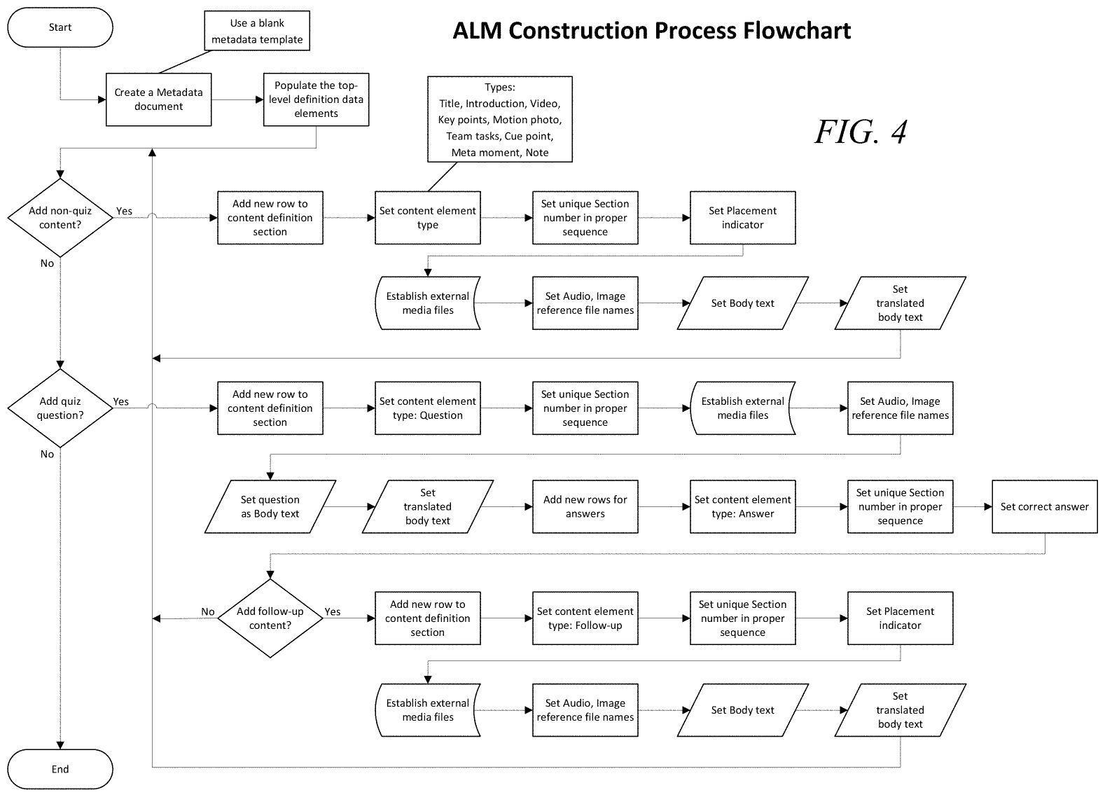

FIG. 4 is a flow chart exemplifying in greater detail the process of constructing an ALM comprising content and quiz questions relating to the content.

Once an ALM is generated by the module assembler, it can then be imported into a compatible Learning Management System (“LMS”) to be presented to trainees. The LMS is described in greater detail in U.S. Pat. No. 8,356,068 issued Jan. 15, 2013, and U.S. Pat. No. 9,691,292 issued Jun. 27, 2017, which patents are incorporated herein by reference in their entireties.

The process of the invention separates the two key elements (i.e., the metadata document and the module assembler) to allow the following activities on each to be carried out efficiently, whereby content is entered by contributors into the metadata document, and assembled by the module assembler to produce a completed ALM.
Topic outline definition
Schematic design
Content targeting
Language-neutral copy
Translation
Reference images
Media assets
Approval workflow
Amendments and rework

The process of the invention starts with the creation of a metadata document. The metadata document contains a set of general “top level” metadata that applies to the entire ALM. The general “top level” metadata preferably includes a customer reference, an account number, a topic description, dates and times, and the like. The metadata document further includes a description of all the components of the finished module, such as text items, images, illustrations, video, audio, quiz definitions, and the like. The metadata document implicitly defines the structure of the ALM and includes references to the appropriate media components at the locations where they are needed.

The metadata is preferably stored in tables in the metadata document, such as a Microsoft® Word® document. The tables have a predefined structure with known column and row headers. The following are provided by way of examples, but not limitations.

General Top-Level Definition

| | |
|---|---|
| Client | ABC Inc. |
| Module Topic | January Safety Training - Warehouse Safety |
| Module Code | ABCWHS |
| Module Version | 001 |
| Date | Dec. 1, 2018 |
| Account Number | ABC1234 |

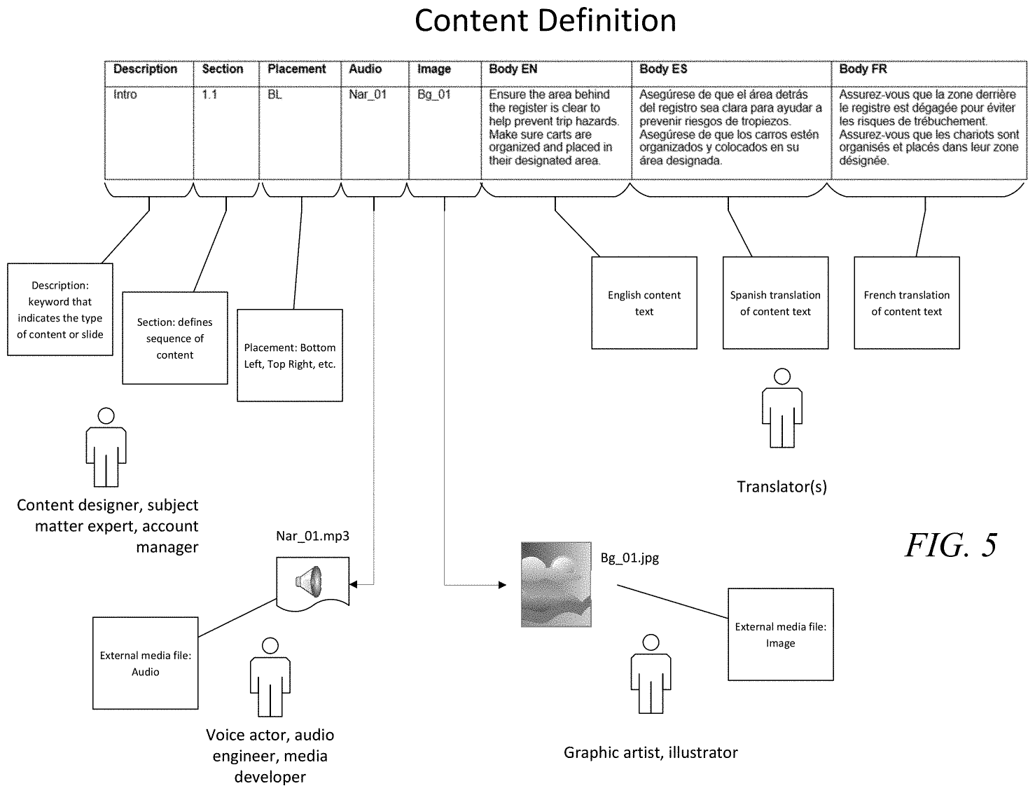

FIG. 5 exemplifies a table for entering content definition. As depicted below and in FIG. 5, audio files and image files are called by references to external files, such as Nar_01 and Bg_01, which are supplied by the External Media Elements (FIG. 3). Calls to external files may also be made using abstract definitions, such as a URL, a file path, or the like. Text entered into the body of a slide may be entered directly into the table, or into an external text file that would be called by reference. Blanks in the table may mean that an entry is not needed or is not applicable for that field, or that there is a reasonable default value that can be supplied by the module assembler.

| Description | Section | Placement | Audio | Image | Body EN | Body ES | Body FR |
|---|---|---|---|---|---|---|---|
| Intro | 1.1 | BL | Nar_01 | Bg_01 | Ensure the area | Asegúrese de | Assurez-vous |
| | | | | | behind the | que el área | que la zone |
| | | | | | register is clear | detrás del | derrière le |
| | | | | | to help prevent | registro sea | registre est |
| | | | | | trip hazards. | clara para | dégagée pour |
| | | | | | Make sure carts | ayudar a | éviter les |
| | | | | | are organized | prevenir | risques de |
| | | | | | and placed in | riesgos de | trébuchement. |
| | | | | | their designated | tropiezos. | Assurez-vous |
| | | | | | area. | Asegúrese de | que les chariots |
| | | | | | | que los carros | sont organisés |
| | | | | | | estén | et placés dans |
| | | | | | | organizados y | leur zone |
| | | | | | | colocados en | désignée. |
| | | | | | | su área | |
| | | | | | | designada. | |
| Intro | 1.2 | | | | Utilize proper | Utilice técnicas | Utilisez les |
| | | | | | lifting | de | techniques de |
| | | | | | techniques by | levantamiento | levage |
| | | | | | keeping it close | adecuadas | appropriées en |
| | | | | | and turning your | manteniéndolo | les gardant |
| | | | | | feet first when | cerca y girando | près et en |
| | | | | | lifting product to | los pies primero | tournant les |
| | | | | | the BOPIS rack. | cuando levante | pieds en |
| | | | | | | el producto al | premier lorsque |
| | | | | | | estante BOPIS. | vous soulevez |
| | | | | | | | le produit sur le |
| | | | | | | | rack BOPIS. |

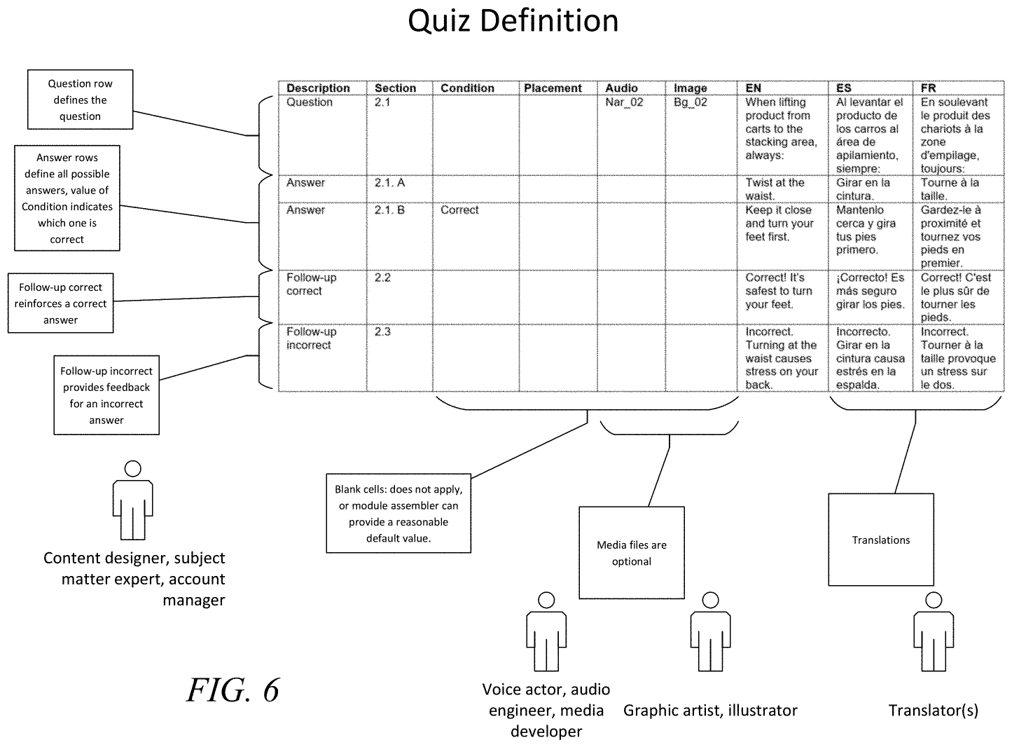

FIG. 6 exemplifies a table for entering quiz definition, similar to the content definition described above with respect to FIG. 5. As depicted below and in FIG. 6, audio files and image files are called by references to external files, such as Nar 02 and Bg 02, which are supplied by the External Media Elements (FIG. 3). Calls to external files may also be made using abstract definitions, such as a URL, a file path, or the like. Text entered into the body of a slide may be entered directly into the table, or into an external text file that would be called by reference. Blanks in the table may mean that an entry is not needed or is not applicable for that field, or that there is a reasonable default value that can be supplied by the module assembler.

| Description | Section | Condition | Placement | Audio | Image | Body EN | Body ES | Body FR |
|---|---|---|---|---|---|---|---|---|
| Question | 2.1 | | | Nar_02 | Bg_02 | | | |
| Answer | 2.1.A | | | | | | | |
| Answer | 2.1.B | Correct | | | | | | |

The metadata document contains one top-level definition table and multiple content definition and quiz definition tables as needed. Examples of multiple sections within a document may look like the following:
Top-level definition
Content definition 1
Content definition 2
Quiz definition A
Content definition 3
Content definition 4
Quiz definition B
Quiz definition C
Content definition 5

As the metadata document is constructed, it is shared with each participant in the construction process. Participants can develop their parts of the metadata document independently and in parallel with other participants. The following is an example:
An art director designs a schematic for the overall structure of an ALM. She indicates that the first element of the course is an illustration, to be followed by a text window. When that work is complete, the metadata document is then provided to an illustrator to use for building the illustration. The illustration is developed and stored separate from the metadata document, and a reference to the illustration is added to the metadata document. At the same time, the metadata document is provided to a subject matter expert. She writes the copy for the text window and stores it in the metadata document. When she is complete, the metadata document is then forwarded to translators who write the French and Spanish versions of the copy written by the subject matter expert. When they are complete, the changes among the contributors are merged into a common metadata document that includes all the changes from every contributor.

Some individual steps can be repeated without interfering with any parallel tasks that may be occurring. Changes due to revisions do not necessarily halt the entire process.

Once enough development has been completed, the module assembler can be invoked to build the completed module.

Steps involved in construction of the ALM:

| | |
|---|---|
| 1. | The ALM name is preferably established by concatenating element value of |
| | top-level definition metadata items. |
| | ∘ Example: “ABCWHSv001-2018-12-01.01.ZIP” |
| 2. | External reference file names and relative locations are preferably established |
| | by combining element values of top-level definition metadata items with |
| | element values in content or quiz definitions. |
| | ∘ Example audio: “<root>/audio/ABCWHS_Nar01.mp3” |
| | ∘ Example image: “<root>/images/ABCWHS_Bg01.png” |
| 3. | The module assembler generates an outline, preferably in XML format, of the |
| | required ALM using the metadata definition tables as a template. The ALM is |
| | formatted to the schema required by the system that will be consuming the |
| | ALM for playback to the trainee. |
| | ∘ Example. In the case of the sample outline above, the XML outline |
| | would be as follows: |
| | <?xml version=“1.0” encoding=“UTF-8”?> |
| | <content> |
| | <context> |
| | <module_type>training</module_type> |
| | <module_code>ABCWHS</module_code> |
| | </context> |
| | <intro> |
| | <page/> |
| | <page/> |
| | </intro> |
| | <question> |
| | <answer/> |
| | <answer/> |
| | <answer/> |
| | </question> |
| | <followUpCorrect> |
| | <page /> |
| | </followUpCorrect> |
| | <followUpIncorrect> |
| | <page /> |
| | <page /> |
| | <page /> |
| | </followUpIncorrect> |
| | </content> |
| 4. | Attributes and element values are derived from the metadata tables for the |
| | corresponding sections. |
| | ∘ Example page definition: |

<page section=“1.1” placement=“MR” audio=“audio/nar_01_D90_Cashiers.mp3”
image=“images/bg_01_D90_Cashiers.jpg”>Ensure the area behind the desk and/or register is
clear to help prevent trip hazards. Make sure carts are organized and placed in their designated
area.</page>

∘ Example quiz question and answer definitions:

```
      <content section=“2.1” audio=“audio/nar_04_D90_Cashiers.mp3”
image=“images/bg_04_D90_Cashiers.jpg”>When lifting product from carts to the stacking area,
always:</content>
      <answer correct=“false”>Twist at the waist.</answer>
      <answer correct=“true”>Keep it close and turn your feet first.</answer>
```

In one preferred embodiment, the generated ALM can be uploaded to the MPS configured to generate presentation materials (e.g., PowerPoint slides) which can be uploaded to the target training system (e.g., LMS) to be reviewed. It is contemplated that in an alternate embodiment, a program such as PowerPoint may convert ALM XML directly into a series of presentation slides for LMS, or other training system, thereby bypassing the MPS. It is not necessary to complete all development; the module assembler can preferably compensate for missing component media items by substituting placeholder items where the finished items should be. It will also generate media placeholders on the fly using algorithmic techniques or software services.
An example of a media placeholder could be a voice-over audio file. When the text of the voice-over is known, but the actual voice-over recording is not yet available, the module assembler can use text-to-speech services to generate voice-over audio as a rough approximation of the final audio.

Upon review, it may be determined that revisions are necessary. In the revision cycle, the contributors responsible for implementing the revisions will preferably make their changes to the original metadata document, and not to the reviewed ALM. In fact, the ALM can be discarded as it contains nothing that cannot be re-generated at any time. Once the revisions are made, the module assembler is invoked once more to generate a new ALM and the review is carried out on this new ALM.

When multiple variations of the finished product are required, the process is very similar to that of revisions. Changes can be made directly to the metadata document, then the module assembler generates variants of the ALMs as required. In such case, each ALM is a unique finished product.

For variants that are significantly different, the metadata document itself can be replicated manually. The copy can then be modified as required to generate the desired output.

### Operation

Contributors in the inventive process never use any of the traditional GUI-based tools to construct the content. They simply write specifications for the structure and content of the final output. The module assembly tool takes responsibility for the actual construction of the content objects themselves.

To examine this in more detail, an example of a content element can be an image with a text overlay. In accordance with the prior art, construction of the content element requires the creator to carry out several steps using a traditional creative software tool, such as PowerPoint:
(1) Use the tool to create a content element (e.g., a new slide, a new window, etc.)
(2) Use the tool to insert an image. The tool prompts the creator to enter the location of the image on a local computer, network, or the like. The user selects the image. The tool then imports the image into the content design window.
(3) Use the tool to place a text overlay on the image. The tool creates a blank placeholder of the overlay on the design window. The creator adjusts the overlay to set it to the required size and position. The creator then invokes the function to enter the text contents of the overlay.

In accordance with the present invention, and with reference to FIGS. 3-7, the creator works within the metadata document exclusively. To create a new image slide with a text overlay, the creator inserts a metadata element into a row of the metadata document content definition (FIG. 5) with a keyword in the “Description” column that indicates the type of element, such as an “image slide”. An image slide element requires a reference to an image, so the creator specifies the location of an image file (e.g., “Bg_01”) residing in External Media Elements on a computer, such as a local computer or a network. An image slide also allow for an optional text overlay. The creator may make use of a text overlay by setting a parameter to enable the text overlay, and specify parameter values that describe the size, position, and text contents of the overlay.

Note that this process does not allow the creator to visually see the results of the settings when those parameters are specified. This is only available when the module assembler constructs the module and it is executed for review. The tools can be designed to minimize this edit-assemble-review cycle by providing a preview function that can be invoked on the metadata document.

A key point is that this process relies on the creator's ability to visualize the desired output and their ability to adjust the content design even with a delay between the output specification and the final result. By sacrificing instant feedback, this process maximizes productivity by boosting the repeatability of the design cycle. If instead of one image slide with a text overlay, the requirements indicated a need for 100 image slides with a text overlay on each, then a GUI-based tool would require a creator to repeat the same GUI actions over and over. Even with shortcuts that allow the creator to copy and paste a content element, they would need to manually adjust every single slide, and would need to visually review every slide to ensure the output is correct.

Using the novel process of the present invention the creator would insert 100 rows into the metadata document. The preferred approach would be to insert the first row manually and copy/paste the row 99 more times. Then, for each row, the adjustments can be made on every slide via the metadata document. The creator would be able to see all 100 slide definitions on the same screen at the same time to quickly verify that each one is properly specified. If an error is found or edit is desired, then instead of opening an ALM and navigating to the specific slide itself, the creator would only need to fix the error in the list of slide definitions. It would be easy to pick out the problematic definition among all the other definitions on the same screen.

In another example, if it is desired to change the background image reference in 100 slides, using prior art GUI technology, a creator would need to visit every slide, remove the existing background image, and paste in the new background image. Using the present invention, a creator would simply open the appropriate table in the metadata document, copy the name or reference of the new image, and then paste it into every cell at once.

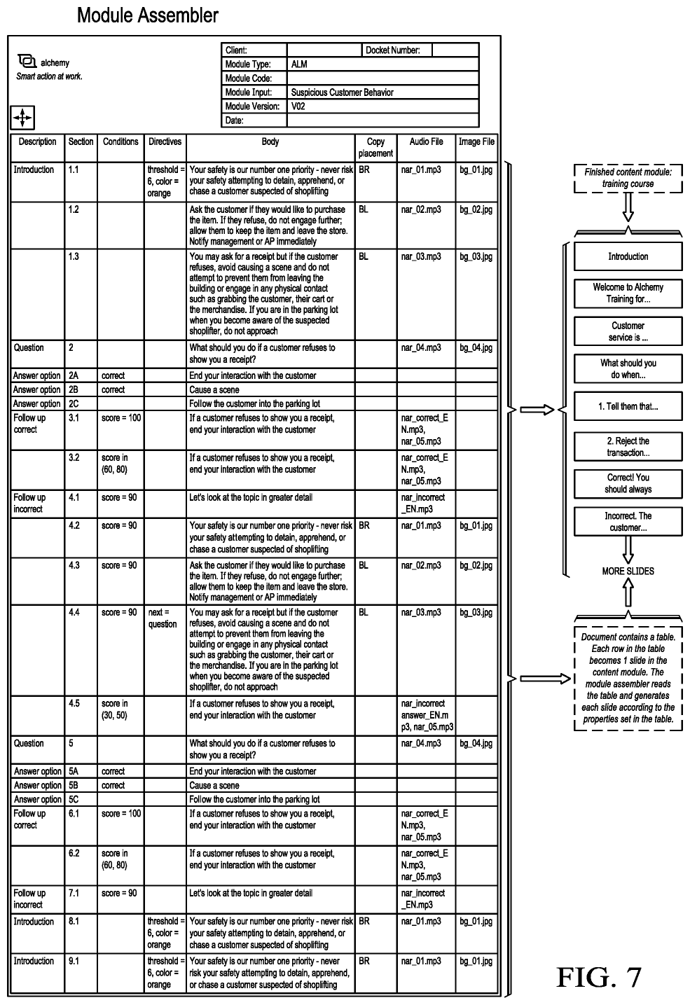

In yet another example, with reference to FIG. 7, the MPS generates from the ALM a PowerPoint slide presentation. Assume that each slide has an image embedded in it, and each slide is placed in a different corner of the slide, according to the table in the metadata document. A decision is then made to position those images consistent throughout, at the bottom left (“BL”) corner. By traditional means, the creator would need to edit each slide one at a time and move the image to the correct placement. With the present invention, the creator would simply modify the “Placement” column in the table inside the metadata document and paste “BL” into every cell in that column. The module assembler would then generate as output a new PowerPoint slide presentation, but now every slide has the image placed at the bottom left. The pasting of “BL” into every cell could be further automated by using a special character, such as “=” to set the value in any number of cells equal to the value of a selected cell. Then when the value in the selected cell is modified, all other cells set equal to the selected cell would automatically be modified as well. More complex operations are contemplated, too. By way of example, a special sequence could be defined, such as “=+10” which would mean “the same as the previous row value plus 10”. This could be used to adjust the width and height of a background image such that the image gets bigger by 10 pixels on every slide. VARIATIONS

While the embodiment of the invention described above preferably uses a Microsoft® Word® document to store the metadata information, any common document format may be used. The only requirements for a document are that the document is preferably in a format understandable by widely available tools, can be read and interpreted by software, and can store text in any of the languages that the final product must be rendered to. This can be other office applications (Excel, Access, Open Office applications) or more generic text formats (JSON, XML, or TXT). The most important requirements are that the format is understandable by all stakeholders and contributors, and that it is formatted in a consistent manner to allow it to be parsed by the module assembler. Note that generic text formats require adherence to a common pre-defined structure for the element definitions.

An alternative implementation may not use an office document at all, but instead present the definition of the metadata via a forms-based application. The user could use input forms to define the course structure and contents, then the application could store these definitions in a common location like a database. Other stakeholders can be given the same access to these common definitions. It is noted that the front end of the metadata document may be like www.smartling.com or www.lingotek.com, but the module assembly process is still unique.

The module assembler can be implemented in various architectures and on various OS and hardware platforms with equal effectiveness. These could be online/web/software-as-a-service, desktop software, mobile/tablet applications, or otherwise any computer platform that has standard input/output capability.

The new process applies to all types of content that are media types currently or potentially supported by common computer platforms. These include audio; video; video overlay; text; images; interactive graphics; 3D graphics; augmented, virtual, or mixed reality; 360-degree imagery or video; numeric or other report data; computer-generated speech, digital signage content.

The metadata document could be split into multiple parts to represent different topics or course material, or to represent the different sections of the resulting course such as introduction, remediation, etc.

The ALM is not limited to XML format. Once the metadata document is parsed, the output can be generated in multiple forms, depending on the system into which the content will be imported:
JSON, CSV, SQL, and the like;
Set of files and folders; and
Compressed package: ZIP, RAR, 7z, and the like.

### Other Uses

Other uses may include its use as a means of generating other types of digital documents, such as the following:
Technical documentation—instruction manuals, user guides, repair manuals, etc.
Web sites—when multiple similar web sites are needed
Web applications—metadata can embed software source code
Advertising—online or mobile media
Media formats: MP4, Blu-Ray, digital media streams
Web banner ads
CDN content
CNC machine inputs
3D printer instructions
Print-ready PDF files

### Results Achieved by the Invention

A test was carried out in Alchemy Systems, Guelph Ontario office. Test details and results are listed below.

| | |
|---|---|
| Goal | Create a training module using pre-constructed assets. Trainees |
| | will require 2 minutes to play the module. |
| Test 1 | Use Articulate Storyline to construct the module. |
| | Requires a skilled developer. |
| Results | Total time required: 90 minutes. |
| Test 2 | Use the Alchemy “Smart Content Builder” - an internal tool |
| | that implements the proposed process. |
| Results | A warehouse worker was recruited with no graphic design skills. |
| | They required less than 10 minutes to learn to use the tool. |
| | Total time required: 2 minutes. |

### Advantages:

By using the present invention, module construction time can be reduced by 97% for a 2-minute training module. Overall project delivery time may be reduced by 15%.

The present invention also includes a number of technical advantages. For example, the present invention uses computer resources more efficiently because it requires less computer memory than is required by prior art because each media element is stored only once and called as necessary to generate an ALM. Still further, because an ALM can be readily generated, it does not need to be saved in memory, thereby further conserving computer memory.

Conventional tools are designed to be operated with manual intervention, as a digital equivalent of an artist's canvas and palette. As such, it must be directly available to all contributors by local installation of software. In contrast, an advantage of the module assembler of the present invention is that it operates as a background process, providing opportunities to optimize cost and/or throughput by providing choices for deployment; for example, it can be deployed on a server, in the cloud, or locally. Server and cloud deployments have other advantages such as the ability to roll out corrections to software defects only once on the server instead of on each client workstation.

Another advantage of the invention is that a single metadata document can simultaneously describe multiple possible outputs. For example, the content definition tables show how multiple languages are represented. This technique can also be extended to represent multiple roles, geographies, business units, and the like. If there were, for example, two roles, four locations, three business units, and three languages, a conventional process would potentially require seventy-two different source documents, whereas the present process only requires one source documents, thus saving memory space and processing power.

A still further advantage of the invention is that it uses widely available construction tools (e.g., MS Office) and Internet web technologies (HTML5, JavaScript, CSS), thus assuring compatibility with the target systems and avoiding compatibility issues that may be present with proprietary software used in conventional processes.

It is understood that the present invention may take many forms and embodiments. Accordingly, several variations may be made in the foregoing without departing from the spirit or the scope of the invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A method for automating the authoring and assembly of Adaptive Learning Modules (“ALM” aka an “output content module file”), the method comprising:
creating external media elements accessible by reference;
creating a metadata document having text and references to the external media elements;
generating by a module assembler the ALM from the metadata document text and external media elements referenced in the metadata document, the ALM comprising assets and assembly rules; and
using media player software (“MPS”) to generate from the ALM assets and assembly rules, presentation materials usable in a training system.

2. The method of claim 1, wherein creating a metadata document is performed by multiple contributory sources simultaneously.

3. The method of claim 1, wherein the training system is a Learning Management System (“LMS”).

4. The method of claim 1, wherein the external media elements are training elements.

5. The method of claim 1, wherein text includes training content.

6. The method of claim 1, wherein text includes quiz content.

7. The method of claim 1, wherein text includes data for placement of elements.

8. The method of claim 1, wherein external media elements include audio files.

9. The method of claim 1, wherein external media elements include image files.

10. The method of claim 1, wherein external media elements include at least one of audio; video; video overlay; text; images; interactive graphics; 3D graphics; augmented, virtual, or mixed reality; 360-degree imagery or video; numeric or other report data; computer-generated speech, digital signage content.

11. The method of claim 1, wherein the presentation materials include PowerPoint slides.

12. The method of claim 1, wherein the metadata document includes a top level definition table, one or more content definition tables, and one or more quiz definition tables, each of which tables include a plurality of rows and a plurality of columns, the first row of each table being a header row defining a category of at least one of (1) data that will be stored and (2) external media elements that will be referenced.

13. A system for automating the authoring and assembly of Adaptive Learning Modules (“ALM” aka an “output content module file”), the system comprising:
a module assembler configured for receiving external media elements accessible by reference and a metadata document having text and references to the external media elements, the module assembler being configured for generating the ALM from the metadata document text and external media elements referenced in the metadata document, the ALM comprising assets and assembly rules; and
media player software (“MPS”) configured to generate from the ALM assets and assembly rules, presentation materials usable in a training system.

14. The system of claim 13, wherein the training system is a Learning Management System (“LMS”).
